(19) United States
(12) Patent Application Publication
(10) Pub. No.: US 2022/0264242 A1
(43) Pub. Date: Aug. 18, 2022

(54) AUDIO OUTPUT APPARATUS AND AUDIO OUTPUT SYSTEM USING SAME

(71) Applicant: SONY GROUP CORPORATION, TOKYO (JP)

(72) Inventors: TETSU MAGARIYACHI, TOKYO (JP); KAZUNOBU OOKURI, TOKYO (JP)

(21) Appl. No.: 17/628,309

(22) PCT Filed: Jul. 16, 2020
(86) PCT No.: PCT/JP2020/027720

§ 371 Date: Jan. 19, 2022

(30) Foreign Application Priority Data
Aug. 2, 2019 (JP) 2019-142880

(51) Int. Cl. H04S 7/00; G06T 7/60; H04R 1/10

(52) U.S. Cl. CPC H04S 7/301; H04S 2420/01; H04R 1/1091; G06T 7/60

(57) ABSTRACT

To provide an audio output apparatus capable of instantly providing sound to a given listener through high-quality binaural reproduction. An audio output apparatus is configured to be wearable on a listener and includes a pair of output units and an imaging unit. The pair of output units is configured to be capable of outputting audio output signals generated using a head-related transfer function to both ears of the listener in a wearing state in which the audio output apparatus is worn, respectively. The imaging unit is provided in at least one of the pair of output units and is configured to be capable of generating an image by imaging the ears of the listener in the wearing state, the image being used for calculating the head-related transfer function. In this configuration, by using the imaging unit in the pair of output units, the image of the listener's ears to be used for calculating the head-related transfer function can be generated after the listener wears the audio output apparatus. Therefore, this audio output apparatus can instantly provide sound through high-quality binaural reproduction to a given listener.

### TECHNICAL FIELD

The present technology relates to a wearable-type audio output apparatus and to an audio output system using the same.

### BACKGROUND ART

A binaural reproduction technology capable of allowing a listener to perceive a position of a sound image in a particular space through output of audio signals by a wearable-type audio output apparatus such as headphones and earphones has attracted attention. For binaural reproduction, a head-related transfer function that represents how sound is transmitted to eardrums of both ears of a listener from a surrounding space is used.

It is known that the head-related transfer function has a significant individual difference due to an ear shape difference between listeners. According to a technology described in Patent Literature 1, the use of an image generated in advance by imaging listener's ears through a built-in camera of a portable terminal device or the like for calculating a head-related transfer function makes it possible to provide sound to a given listener through high-quality binaural reproduction.

### CITATION LIST

### Patent Literature

Patent Literature 1: WO 2017/047309

### DISCLOSURE OF INVENTION

### Technical Problem

However, the technology described in Patent Literature 1 needs to generate an image of listener's ears and calculate a head-related transfer function by using the image before outputting audio signals to the listener. Therefore, in this technology, it is difficult to instantly provide a new listener whose ear shape is unknown with sound through binaural reproduction.

In view of the above-mentioned circumstances, it is an object of the present technology to provide an audio output apparatus capable of instantly providing sound to a given listener through high-quality binaural reproduction and an audio output system using the same.

### Solution to Problem

In order to accomplish the above-mentioned object, an audio output apparatus according to an embodiment of the present technology is configured to be wearable on a listener and includes a pair of output units and an imaging unit.

The pair of output units is configured to be capable of outputting audio output signals generated using a head-related transfer function to both ears of the listener in a wearing state in which the audio output apparatus is worn, respectively.

The imaging unit is provided in at least one of the pair of output units and is configured to be capable of generating an image by imaging the ears of the listener in the wearing state, the image being used for calculating the head-related transfer function.

In this configuration, the use of the imaging unit in the pair of output units enables the image of the listener's ears that is used for calculating the head-related transfer function to be generated after the listener wears the audio output apparatus. Therefore, this audio output apparatus can instantly provide sound through high-quality binaural reproduction to a given listener.

The audio output apparatus may further include a detection unit that detects the wearing state.

The audio output apparatus may further include an imaging control unit that drives the imaging unit on the basis of a result of the detection of the detection unit.

The audio output apparatus may further include a calculation unit that calculates the head-related transfer function by using the image generated by the imaging unit.

The audio output apparatus may further include a generation unit that generates the audio output signals by using the head-related transfer function.

The audio output apparatus may further include a correction unit in which a correction function having an effect of reducing influences of the imaging unit on output of the audio output signals from the pair of output units has been recorded.

The pair of output units may cover the listener's ears in the wearing state.

The imaging unit may include an irradiator that emits light to the listener's ears in the wearing state.

An audio output system according to an embodiment of the present technology includes an audio output apparatus, a calculation unit, and a generation unit.

The audio output apparatus is configured to be wearable on a listener and includes a pair of output units configured to be capable of outputting audio output signals generated using a head-related transfer function to both ears of the listener in a wearing state in which the audio output apparatus is worn, respectively, and an imaging unit that is provided in at least one of the pair of output units and is configured to be capable of generating an image by imaging the ears of the listener in the wearing state, the image being used for calculating the head-related transfer function.

The calculation unit calculates the head-related transfer function by using the image generated by the imaging unit.

The generation unit generates the audio output signals by using the head-related transfer function.

The audio output system may further include: a recording unit in which the head-related transfer function calculated by the calculation unit is registered; and a determination unit that determines whether or not a head-related transfer function corresponding to the image generated by the imaging unit has been registered in the recording unit.

### BRIEF DESCRIPTION OF DRAWINGS

FIG. 1 A perspective view of an audio output apparatus according to an embodiment of the present technology.

FIG. 2 A plan view showing an output unit of the audio output apparatus from inside.

FIG. 3 A block diagram showing a configuration of an audio output system using the audio output apparatus.

FIG. 4 A flowchart showing an operation of the audio output system.

FIG. 5 A front view showing another embodiment of the audio output apparatus.

FIG. 6 A front view showing another embodiment of the audio output apparatus.

FIG. 7 A front view showing another embodiment of the audio output apparatus.

FIG. 8 A front view showing another embodiment of the audio output apparatus.

FIG. 9 A diagram showing another embodiment of processing of a calculation unit of the audio output apparatus.

FIG. 10 A block diagram showing a configuration of an information processing apparatus to be used in another embodiment of the audio output system.

FIG. 11 A flowchart showing an operation of the other embodiment of the audio output system.

### MODE(S) FOR CARRYING OUT THE INVENTION

[Audio Output Apparatus 1 and Audio Output System 100]

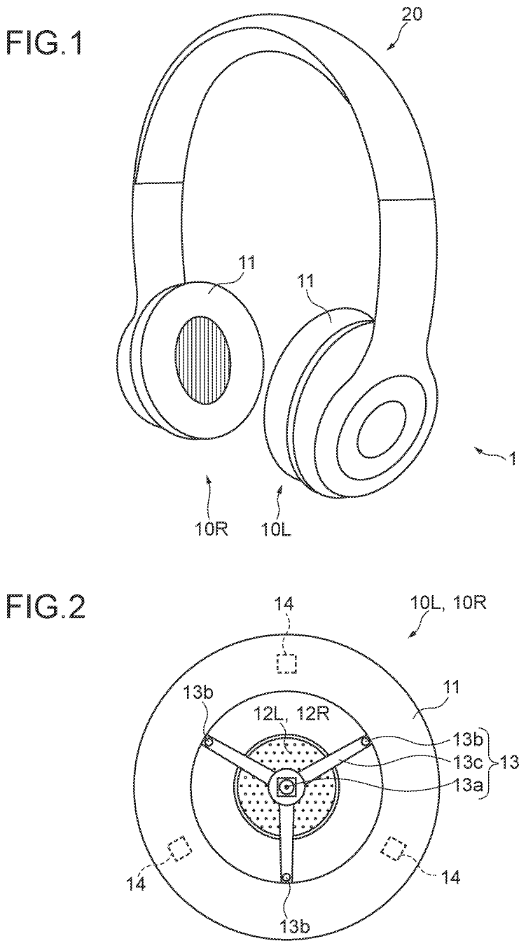

FIG. 1 is a perspective view of an audio output apparatus 1 according to an embodiment of the present technology. The audio output apparatus 1 shown in FIG. 1 is configured as overhead-type headphones wearable on the head of a listener. The audio output apparatus 1 includes a pair of a first output unit 10L and a second output unit 10R and a headband 20 that connects them.

The output units 10L and 10R are located at both end portions of the headband 20 having a U-shape and face each other inward. As to the listener in a wearing state in which the audio output apparatus 1 is worn, the first output unit 10L covers the left ear, the second output unit 10R covers the right ear, and the headband 20 extends over the head in left and right directions.

In the audio output apparatus 1, the output units 10L and 10R have similar configurations. FIG. 2 is a plan view showing the output unit 10L or 10R from the inside that faces the listener's ear in the wearing state. The output units 10L and 10R each include an ear pad 11, an output unit 12L or 12R, an imaging unit 13, and a detection unit 14.

The ear pads 11 of the output units 10L and 10R are donut-shaped members having cushioning properties. The ear pads 11 surround and hermetically seal the listener's ears in the wearing state. Accordingly, the audio output apparatus 1 has a hermetically sealed-type configuration in which both ears of the listener are hermetically sealed, and sound that is emitted from an external environment and enters the ears of the listener can be reduced.

Each of the output units 12L and 12R is configured as a driver that is arranged in a middle region inside the ear pad 11 and generates sound toward the listener's ear in the wearing state. The output unit 12L or 12R is not limited to a particular driving system, and, for example, can be configured as a dynamic-type, balanced armature-type, a capacitor-type, or the like.

The imaging unit 13 includes a camera 13a, irradiators 13b, and retainers 13c. The camera 13a and the irradiators 13b are retained by the retainers 13c. The camera 13a is arranged in a center portion of a space inside the ear pad 11. The irradiators 13b are arranged at three positions adjacent to the inside of the ear pad 11 at substantially equal intervals.

The camera 13a includes an imaging element, a lens, and the like and is configured to be capable of imaging the listener's ear in the wearing state. The imaging element is not limited to a particular one, and for example, may be one having sensitivity to any one of a visible light region, an infrared light region, and an ultraviolet light region. Moreover, the camera 13a may generate a plurality of time-sequential images such as moving images other than still images.

The irradiators 13b include a light source and is configured to be capable of emitting light toward the listener's ear in the wearing state. The light source is not limited to a particular one, and for example, an LED light source, an organic EL light source, or the like can be used. Moreover, the light emitted by the irradiators 13b may be any one of visible light, infrared light, and ultraviolet light.

With such a configuration, the imaging unit 13 can perform imaging through the camera 13a while emitting light to the listener's ear in the wearing state through the irradiators 13b. Accordingly, the imaging unit 13 is capable of generating a clear image of the listener's ear also in a space that is covered with the output unit 10L or 10R and light does not enter from the external environment.

The detection unit 14 is configured to be capable of detecting the wearing state of the audio output apparatus 1 in the listener. Specifically, the detection unit 14 includes piezoelectric elements embedded at three positions inside the ear pad 11. Accordingly, the audio output apparatus 1 is capable of determining whether or not the wearing state is achieved on the basis of a pressure added to the ear pad 11, which is detected by the detection unit 14.

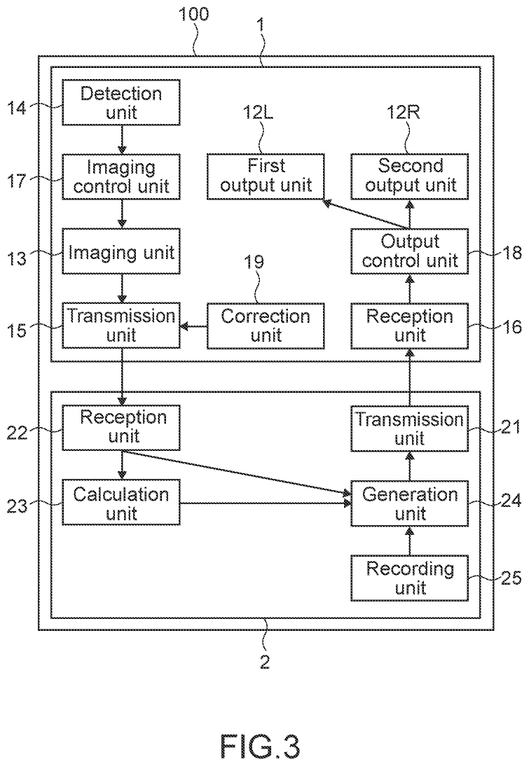

FIG. 3 is a block diagram showing a configuration of an audio output system 100. The audio output system 100 includes an audio output apparatus 1 and an information processing apparatus 2. As the information processing apparatus 2, an arbitrary apparatus capable of performing various types of information processing can be used, and for example, a portable terminal device such as a smartphone, a mobile phone, and a tablet can be used.

The audio output system 100 is configured such that transmitting and receiving can be performed between the audio output apparatus 1 and the information processing apparatus 2. That is, the audio output apparatus 1 includes a transmission unit 15 and a reception unit 16 for transmitting and receiving signals to/from the information processing apparatus 2. Moreover, the information processing apparatus 2 includes a transmission unit 21 and a reception unit 22 for transmitting and receiving signals to/from the audio output apparatus 1.

Moreover, the audio output apparatus 1 includes an imaging control unit 17 that controls driving of the imaging unit 13 and an output control unit 18 that controls output of the output units 12L and 12R. The imaging control unit 17 and the output control unit 18 is, for example, configured as a central processing unit (CPU), a micro processing unit (MPU), or the like, and may be integrally configured or may be separately configured.

The imaging control unit 17 drives the imaging unit 13 on the basis of a result of the detection of the detection unit 14. That is, the imaging control unit 17 causes the imaging units 13 to image the listener's ears, considering the listener's wearing motion of the audio output apparatus 1 as a trigger. Therefore, in the audio output apparatus 1, it is unnecessary for the listener or the like to perform a special operation in order to image the listener's ears.

The output control unit 18 causes the output units 12L and 12R to output audio output signals that are audio data for binaural reproduction, which are transmitted from the information processing apparatus 2. Moreover, the output control unit 18 may be configured to be capable of changing the output of the output units 12L and 12R in accordance with an operation (e.g., sound volume change, mute) made by the listener or the like.

Moreover, the audio output apparatus 1 includes a correction unit 19 in which a correction function having an effect of reducing influences to the output of the audio output signals due to product specifications such as arrangement of the imaging units 13 has been recorded. Accordingly, the audio output apparatus 1 is capable of preventing lowering of the sound quality due to the product specifications. The correction unit 19 is incorporated as a read only memory (ROM) or the like during the manufacture of the audio output apparatus 1, for example.

The information processing apparatus 2 includes a calculation unit 23, a generation unit 24, and a recording unit 25. The calculation unit 23 calculates a head-related transfer function (HRTF). The calculation unit 23 is capable of generating a head-related transfer function corresponding to the listener's ear shapes by using listener's ear images generated by the imaging units 13 of the audio output apparatus 1.

The recording unit 25 is configured as a recording device in which audio input signals or the like that are sound source data to be a target for reproducing a sound image have been recorded. The generation unit 24 generates audio input signals recorded in the recording unit 25 and audio output signals output from the output units 12L and 12R by using the above-mentioned head-related transfer function calculated by the calculation unit 23, the correction function recorded in the correction unit 19, and the like.

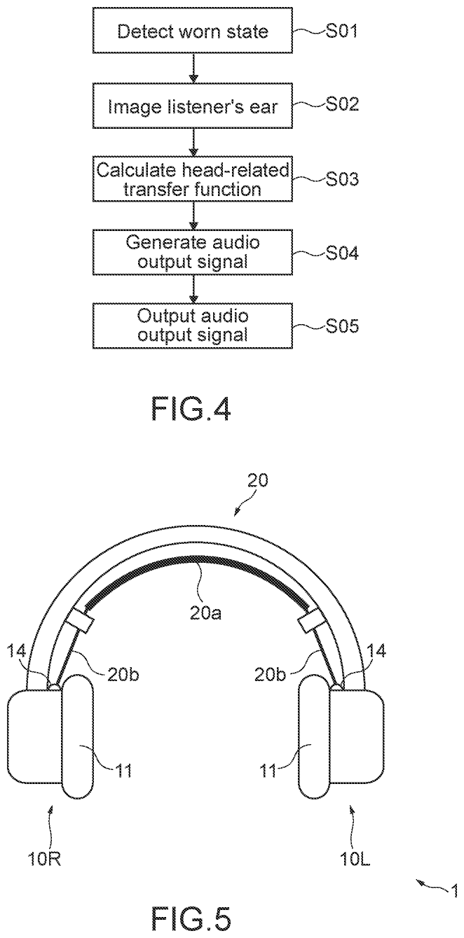

FIG. 4 is a flowchart showing an operation of the audio output system 100 using the audio output apparatus 1. First of all, in the audio output apparatus 1, when the detection unit 14 has detected the wearing state of the listener (Step S01), the imaging control unit 17 causes the imaging units 13 to be driven to thereby image the listener's ears (Step S02).

The audio output apparatus 1 transmits listener's ear images generated by the imaging units 13 in Step S02 and the correction function recorded in the correction unit 19 from the transmission unit 15 to the information processing apparatus 2. The information processing apparatus 2 receives, through the reception unit 22, the listener's ear images and the correction function transmitted from the audio output apparatus 1.

In the information processing apparatus 2, the listener's ear images are transmitted from the reception unit 22 to the calculation unit 23 and the correction function is transmitted from the reception unit 22 to the generation unit 24. The calculation unit 23 calculates the head-related transfer function corresponding to the listener's ear shapes by using the listener's ear images (Step S03) and transmits the generation unit 24 to the calculated head-related transfer function.

The generation unit 24 loads the audio input signals recorded in the recording unit 25 and generates audio output signals from the audio input signals (Step S04). Specifically, in order to generate the audio output signals from the audio input signals, the generation unit 24 performs convolution of the head-related transfer function and further performs convolution of the correction function with respect to the audio input signals.

The information processing apparatus 2 transmits the audio output signals generated by the generation unit 24 from the transmission unit 21 to the audio output apparatus 1. The audio output apparatus 1 receives the audio output signals transmitted from the information processing apparatus 2 through the reception unit 16 and causes the output control unit 18 to output the audio output signals from the output units 12L and 12R (Step S05).

In the above-mentioned manner, the audio output system 100 can provide sound through high-quality binaural reproduction for each of listeners having different ear shapes. Moreover, in the audio output system 100, the head-related transfer function corresponding to the ear shape can be generated after the listener wears it, and therefore it is possible to instantly provide sound to a given listener through binaural reproduction.

[Another Embodiment of Audio Output Apparatus 1]

(Imaging Unit 13)

The imaging units 13 of the audio output apparatus 1 only need to be capable of imaging the listener's ears in the wearing state, and are not limited to the above-mentioned configuration. For example, the imaging unit 13 may be provided only to one of the output units 10L and 10R. In this case, the audio output apparatus 1 is capable of estimating the other ear shape on the basis of an image of one ear with respect to the listener in the wearing state.

Moreover, the imaging unit 13 does not need to include the irradiators 13b. In this case, for example, by employing a configuration with an infrared camera as the camera 13a or a configuration in which a casing for the output unit 10L or 10R is made transparent and light from the external environment enters the listener's ear, it is possible to generate a clear image of the listener's ear through the camera 13a.

(Detection Unit 14)

The detection unit 14 of the audio output apparatus 1 only needs to be capable of detecting the wearing state of the listener, and is not limited to the configuration with the piezoelectric elements as described above. FIG. 5 is a front view showing an example of the audio output apparatus 1 including the detection unit 14 without the piezoelectric elements. In the audio output apparatus 1 shown in FIG. 5, the detection unit 14 includes a tension sensor.

The audio output apparatus 1 shown in FIG. 5 has a double band structure and is provided with an adjusting band 20a along the inside of the headband 20. The adjusting band 20a is connected to the output units 10L and 10R through connection bands 20b made from elastic material, respectively. The detection unit 14 is configured to be capable of detecting the tension of the connection bands 20b.

In the audio output apparatus 1 shown in FIG. 5, the adjusting band 20a that comes in contact with the head when it is worn by the listener is pushed in toward the headband 20 while extending the connection bands 20b. Therefore, the audio output apparatus 1 shown in FIG. 5 is capable of determining whether or not the wearing state is achieved on the basis of the tension of the connection bands 20b that is detected by the detection unit 14.

It should be noted that the audio output apparatus 1 does not need to include the detection unit 14. In this case, for example, the audio output apparatus 1 is capable of driving the imaging unit 13 through the imaging control unit 17, considering an operation with respect to an operation unit provided in the output unit 10L or 10R, an input operation with respect to the information processing apparatus 2, an operation of opening the output unit 10L or 10R to the left or right, or the like as the trigger.

(Correction Unit 19)

The audio output apparatus 1 does not need to include the correction unit 19. In this case, for example, the audio output apparatus 1 may acquire the correction function from the information processing apparatus 2, a cloud, or the like. Moreover, the audio output apparatus 1 does not need to use the correction function in a case where influences on the output of the audio output signals due to the product specifications such as the arrangement of the imaging unit 13 are small.

(Overall Configuration)

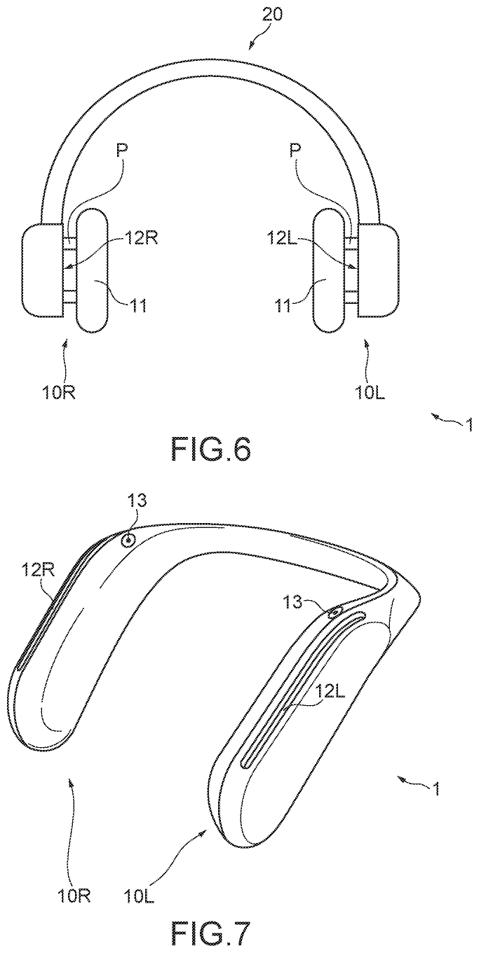

The audio output apparatus 1 does not need to be a hermetically sealed-type, and may be an opened-type. FIG. 6 is a front view showing an example of the audio output apparatus 1 configured as opened-type headphones. In the audio output apparatus 1 shown in FIG. 6, the output units 10L and 10R form a space opened to the external environment without forming the space that hermetically seals the listener's ears.

More specifically, in the audio output apparatus 1 shown in FIG. 6, columnar portions P that form clearances between the output units 12L and 12R and the ear pads 11 are provided in the output units 10L and 10R. Since the peripheries of the columnar portions P are opened, spaces inside the output units 10L and 10R are in communication with an external space through the clearances formed by the columnar portions P.

The audio output apparatus 1 shown in FIG. 6 can provide a wide sound field with no sound muffled in the spaces inside the output units 10L and 10R. Moreover, in the audio output apparatus 1 shown in FIG. 6, external light enters the spaces inside the output units 10L and 10R, and therefore a configuration in which the imaging units 13 are not provided with the irradiators 13b can also be employed.

Furthermore, in the audio output apparatus 1 shown in FIG. 6, the imaging units 13 inside the output units 10L and 10R may be capable of imaging the external environment through the clearances formed by the columnar portions P. In particular, in the imaging unit 13, the use of an ultra-wide angle lens for the camera 13a enables the listener's ears and the external environment to be imaged at the same time.

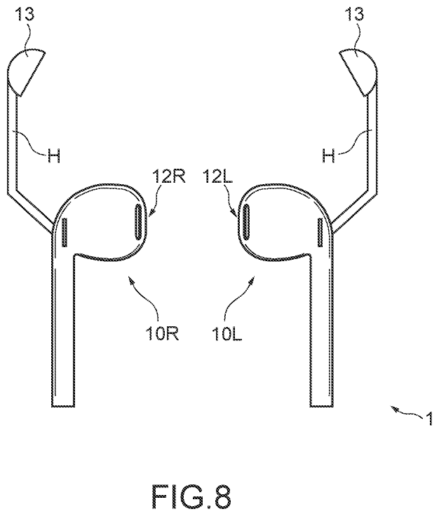

Moreover, the audio output apparatus 1 is a wearable-type that can be worn by the listener, and it is sufficient to include the pair of output units 10L and 10R capable of outputting sound to both ears of the listener in the wearing state, and is not limited to the overhead-type headphones. FIGS. 7 and 8 are front views showing examples of the audio output apparatus 1 having a configuration other than the overhead-type headphones.

The audio output apparatus 1 shown in FIG. 7 is configured as a neck speaker having a U-shaped main body portion. In the audio output apparatus 1 shown in FIG. 7, by the listener wearing it by putting the main body portion on the shoulders from behind the neck, the output units 12L and 12R of the output units 10L and 10R that constitute both end portions of the main body portion face toward the left and right ears of the listener which are positioned above them.

In the audio output apparatus 1 shown in FIG. 7, the imaging units 13 are respectively provided at positions in the output units 10L and 10R, which are adjacent to the output units 12L and 12R, so that the left and right ears of the listener in the wearing state are included in the angles of view. Accordingly, also with the audio output apparatus 1 shown in FIG. 7, the listener's ears in the wearing state can be imaged by the imaging units 13.

The audio output apparatus 1 shown in FIG. 8 is configured as a canal-type earphones in which the output units 12L and 12R of the output units 10L and 10R are inserted into the ear holes. In the audio output apparatus 1 shown in FIG. 8, the imaging units 13 are attached to the output units 10L and 10R via retaining members H so as to be capable of imaging the listener's ears in the wearing state.

It should be noted that the audio output apparatus 1 can also be configured as, for example, inner-ear-type earphones, ear-hanging-type earphones, or the like other than the canal-type earphones. Alternatively, the output units 12L and 12R of the audio output apparatus 1 may be capable of outputting sound through bone conduction of the listener. Alternatively, the audio output apparatus 1 may be configured integrally with another configuration such as eye-glasses.

(Additional Configuration)

The audio output apparatus 1 may be provided with the above-mentioned configurations in a manner that depends on needs. For example, the audio output apparatus 1 may be provided with various sensors such as a gyro sensor, an acceleration sensor, and a geomagnetic sensor. Accordingly, the audio output apparatus 1 is capable of realizing a head tracking function of switching a sound image direction in accordance with a head motion of the listener.

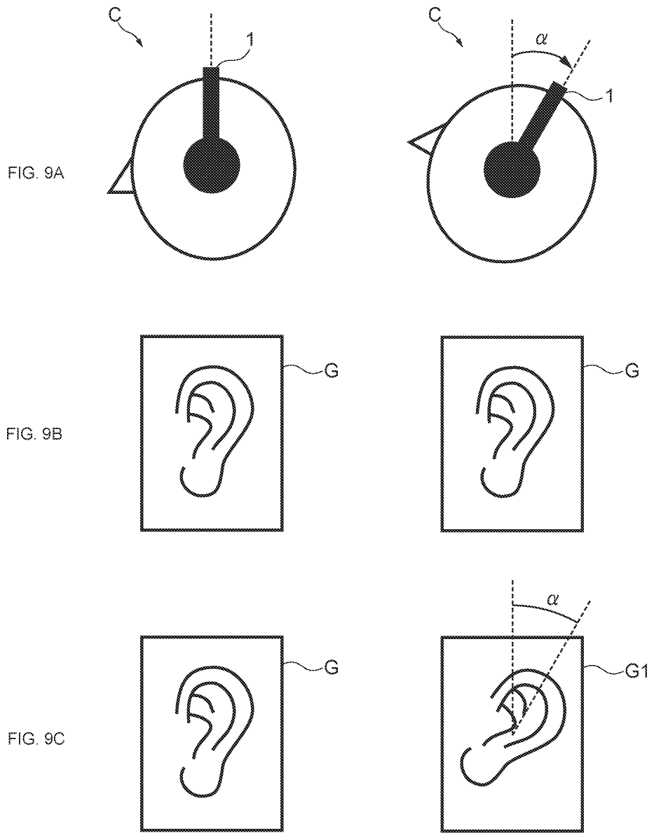

FIG. 9 is a diagram showing a specific example of processing of the calculation unit 23 through various sensors. In FIG. 9A, with respect to a listener C wearing the audio output apparatus 1 normally, a state (left diagram) in which the listener C faces forward and a state (right diagram) in which the listener C faces upward by an angle α are shown. As shown in FIG. 9B, the ear images G captured by the imaging unit 13 are similar in both states.

FIG. 9C shows ear images to be used by the calculation unit 23 for calculating the head-related transfer function. The calculation unit 23 applies, to the image G, correction to tilt by an amount corresponding to the angle α of the head that is acquired from a gyro sensor, for example. That is, the calculation unit 23 uses the image G as it is in a state the angle α of the head is zero (left diagram) and uses an image G1 tilted by an amount corresponding to the angle α of the head in the other state (right diagram).

Accordingly, in the calculation unit 23, a deviation in the sound image direction that is caused by the tendence of the posture or the like of the listener C can be reduced. It should be noted that in the calculation unit 23, the configuration to apply the correction based on the angle α of the head to the ear image G is not essential, and a similar effect can be obtained even with a configuration to apply the correction based on the angle α of the head to the label of the angle of the head-related transfer function calculated on the basis of the ear image G.

Moreover, in the calculation unit 23, by continuously performing correction with the angle α of the head, the sound image direction can be prevented from being deviated due to a change (movement) of the posture of the listener C. Furthermore, monitoring the continuously acquired angle α of the head and performing correction using information regarding the average or the like enables the calculation unit 23 to further effectively reduce the deviation of the sound image direction.

The angle α of the head that the calculation unit 23 acquires from the various sensors is not limited to the angle of elevation of the listener C as described above. The calculation unit 23 only needs to be capable of acquiring at least one of the angle of elevation, the angle of depression, or the azimuth angle of the listener C as the angle α of the head detected by the various sensors, and is favorably capable of acquiring all the angle of elevation, the angle of depression, and the azimuth angle of the listener C.

Moreover, the audio output apparatus 1 may be provided with an external camera capable of imaging the external environment. Accordingly, successively acquiring images of the external environment and performing simultaneous localization and mapping (SLAM) enables the audio output apparatus 1 to output sound that depends on a change in the position or posture of the listener.

[Another Embodiment of Information Processing Apparatus 2]

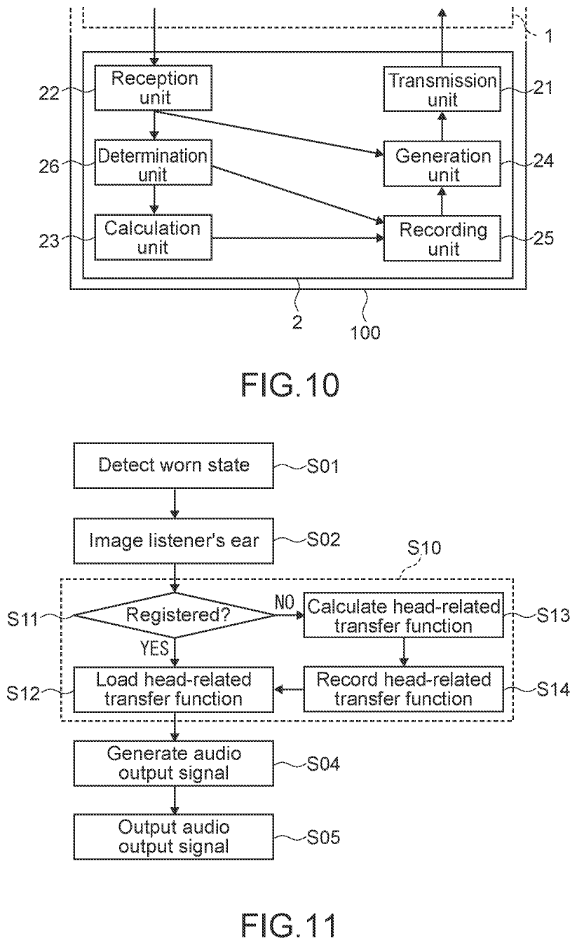

The information processing apparatus 2 only needs to be capable of generating the audio output signals corresponding to the listener's ear shapes, and is not limited to the above-mentioned configuration. FIG. 10 is a block diagram showing a configuration of an example of the information processing apparatus 2 that is different from the above-mentioned one. In the information processing apparatus 2 shown in FIG. 10, a head-related transfer function is calculated using ear images only as initial settings for a new listener.

The information processing apparatus 2 shown in FIG. 10 further includes, in addition to the respective configurations shown in FIG. 3, a determination unit 26 connected between the reception unit 22 and the calculation unit 23. In the information processing apparatus 2 shown in FIG. 10, the head-related transfer function calculated by the calculation unit 23 is registered in the recording unit 25, and the determination unit 26 determines whether or not the head-related transfer function corresponding to the ear images have been already registered in the recording unit 25.

FIG. 11 is a flowchart showing an operation of the audio output system 100 using the information processing apparatus 2 shown in FIG. 10. In the flow shown in FIG. 11, Steps S01, S02, S04, and S05 are common to FIG. 4 and Step S10 (Steps S11 to S14) is performed instead of Step S03 shown in FIG. 4.

In Step S10, the determination unit 26 first determines whether or not the head-related transfer function corresponding to the ear images has been registered in the recording unit 25 (Step S11). In a case where the head-related transfer function has been registered, the head-related transfer function is loaded from the recording unit 25 into the generation unit 24 (Step S12). In a case where the head-related transfer function has not been registered, the calculation unit 23 calculates a head-related transfer function (Step S13).

Then, the head-related transfer function calculated by the calculation unit 23 is registered in the recording unit 25 (Step S14). Accordingly, the calculation of the head-related transfer function by the calculation unit 23 for the listener can be omitted from the second time. Then, the head-related transfer function registered in the recording unit 25 is loaded into the generation unit 24 (Step S12).

It should be noted that the angle α of the head (see FIG. 9) of the listener C at the time of capturing the ear images used for calculating the head-related transfer function may be recorded in the recording unit 25. In this case, in a case where the head-related transfer function has been registered, the determination unit 26 calculates a difference between the angle α of the head at this time and the angle α of the head at the time of the registration and can correct angle information to be used for head tracking by using a result of the calculation.

[Another Embodiment of Audio Output System 100]

The audio output system 100 only needs to be capable of realizing functions similar to those described above, and not limited to the above-mentioned configuration. For example, the audio output system 100 may include, in the audio output apparatus 1, some of the above-mentioned configurations of the information processing apparatus 2. Alternatively, the audio output system 100 may be constituted only by the audio output apparatus 1 including all the above-mentioned configurations of the information processing apparatus 2.

Moreover, the audio output system 100 may cause the cloud to have some of its functions. For example, the audio output system 100 may cause the cloud to have some of the functions of the above-mentioned configurations of the information processing apparatus 2. Alternatively, the audio output system 100 may cause the cloud to have all the functions of the above-mentioned configurations of the information processing apparatus 2 and the audio output apparatus 1 may be configured to be capable of directly communicating with the cloud.

Furthermore, the audio output system 100 can be configured to be capable of performing individual authentication by using the head-related transfer function generated by using the listener's ear images generated by the imaging unit 13. Accordingly, the audio output system 100 is capable of, for example, permitting the utilization of a web service in the information processing apparatus 2 with respect to the authenticated listener.

### OTHER EMBODIMENTS

It should be noted that the present technology can also take the following configurations.

(1) An audio output apparatus that is configured to be wearable on a listener, including:

a pair of output units configured to be capable of outputting audio output signals generated using a head-related transfer function to both ears of the listener in a wearing state in which the audio output apparatus is worn, respectively; and

an imaging unit that is provided in at least one of the pair of output units and is configured to be capable of generating an image by imaging the ears of the listener in the wearing state, the image being used for calculating the head-related transfer function.

(2) The audio output apparatus according to (1), further including

a detection unit that detects the wearing state.

(3) The audio output apparatus according to (2), further including

an imaging control unit that drives the imaging unit on the basis of a result of the detection of the detection unit.

(4) The audio output apparatus according to any one of (1) to (3), further including

a calculation unit that calculates the head-related transfer function by using the image generated by the imaging unit.

(5) The audio output apparatus according to any one of (1) to (4), further including

a generation unit that generates the audio output signals by using the head-related transfer function.

(6) The audio output apparatus according to any one of (1) to (5), further including

a correction unit in which a correction function having an effect of reducing influences of the imaging unit on output of the audio output signals from the pair of output units has been recorded.

(7) The audio output apparatus according to any one of (1) to (6), in which

the pair of output units covers the listener's ears in the wearing state, and

the imaging unit includes an irradiator that emits light to the listener's ears in the wearing state.

(8) An audio output system, including:

an audio output apparatus that is configured to be wearable on a listener, including
a pair of output units configured to be capable of outputting audio output signals generated using a head-related transfer function to both ears of the listener in a wearing state in which the audio output apparatus is worn, respectively, and
an imaging unit that is provided in at least one of the pair of output units and is configured to be capable of generating an image, which is used for calculating the head-related transfer function, by imaging the ears of the listener in the wearing state;

a calculation unit that calculates the head-related transfer function by using the image generated by the imaging unit; and

a generation unit that generates the audio output signals by using the head-related transfer function.

(9) The audio output system according to (8), further including:

a recording unit in which the head-related transfer function calculated by the calculation unit is registered; and

a determination unit that determines whether or not a head-related transfer function corresponding to the image generated by the imaging unit has been registered in the recording unit.

### REFERENCE SIGNS LIST

1 audio output apparatus
10L, 10R output unit
11 ear pad
12L, 12R output unit
13 imaging unit
14 detection unit
15 transmission unit
16 reception unit
17 imaging control unit
18 output control unit
19 correction unit
2 information processing apparatus
21 transmission unit
22 reception unit
23 calculation unit
24 generation unit
25 recording unit
26 determination unit
100 audio output system

1. An audio output apparatus that is configured to be wearable on a listener, comprising:
a pair of output units configured to be capable of outputting audio output signals generated using a head-related transfer function to both ears of the listener in a wearing state in which the audio output apparatus is worn, respectively; and
an imaging unit that is provided in at least one of the pair of output units and is configured to be capable of generating an image by imaging the ears of the listener in the wearing state, the image being used for calculating the head-related transfer function.

2. The audio output apparatus according to claim 1, further comprising
a detection unit that detects the wearing state.

3. The audio output apparatus according to claim 2, further comprising
an imaging control unit that drives the imaging unit on a basis of a result of the detection of the detection unit.

4. The audio output apparatus according to claim 1, further comprising
a calculation unit that calculates the head-related transfer function by using the image generated by the imaging unit.

5. The audio output apparatus according to claim 1, further comprising
a generation unit that generates the audio output signals by using the head-related transfer function.

6. The audio output apparatus according to claim 1, further comprising
a correction unit in which a correction function having an effect of reducing influences of the imaging unit on output of the audio output signals from the pair of output units has been recorded.

7. The audio output apparatus according to claim 1, wherein
the pair of output units covers the listener's ears in the wearing state, and
the imaging unit includes an irradiator that emits light to the listener's ears in the wearing state.

8. An audio output system, comprising:
an audio output apparatus that is configured to be wearable on a listener, including
a pair of output units configured to be capable of outputting audio output signals generated using a head-related transfer function to both ears of the listener in a wearing state in which the audio output apparatus is worn, respectively, and
an imaging unit that is provided in at least one of the pair of output units and is configured to be capable of generating an image, which is used for calculating the head-related transfer function, by imaging the ears of the listener in the wearing state;
a calculation unit that calculates the head-related transfer function by using the image generated by the imaging unit; and
a generation unit that generates the audio output signals by using the head-related transfer function.

9. The audio output system according to claim 8, further comprising:
a recording unit in which the head-related transfer function calculated by the calculation unit is registered; and
a determination unit that determines whether or not a head-related transfer function corresponding to the image generated by the imaging unit has been registered in the recording unit.
